(19) United States
(12) Patent Application Publication
(10) Pub. No.: US 2007/0126262 A1
(43) Pub. Date: Jun. 7, 2007

(54) Floor Seal Connection for a Trailer

(76) Inventors: Leonard W. Baker, Lafayette, IN (US); Rodney P. Ehrlich, Monticello, IN (US); David P. Kunkel, Lebanon, IN (US); Danny Lee Gilbert, Monticello, IN (US)

Correspondence Address: TREXLER, BUSHNELL, GIANGIORGI,;BLACKSTONE & MARR, LTD., 105 WEST ADAMS STREET, SUITE 3600, CHICAGO, IL, 60603, US

(21) Appl. No.: 11/532,388

(22) Filed: Sep. 15, 2006

Related U.S. Application Data
(60) Provisional application No. 60/741,369, filed on Dec. 1, 2005.

(51) Int. Cl. B62D 33/04

(52) U.S. Cl. 296/184.1

(57) ABSTRACT

A trailer having an interior section and an exterior; a base rail separating the interior section from the exterior, the base rail having a flange extending into the interior section; a cross-member attached to the base rail; and a floor seal attached to the cross-member and extending into the interior section, the floor seal spaced from the flange to form a passageway from the interior section to the exterior.

### CROSS-REFERENCE TO RELATED APPLICATION:

This application claims the benefit of priority of U.S. Provisional Patent Application No. 60/741,369, filed on Dec. 1, 2005, which provisional application is hereby incorporated by reference in its entirety.

### BACKGROUND OF THE INVENTION

As is known in the prior art, a trailer generally includes a body having a cargo section enclosed by a pair of rectangular sidewalls, a front wall, at least one rear door, a roof, and a floor. Conventionally, each sidewall includes side panels, a base rail and a top rail. The floor is supported by cross-members that extend between the base rails. An undercaniage assembly is mounted underneath the floor. An upper portion of the side panels is secured to the top rail. The top rail supports the roof of the trailer. The upper portion of the base rail and the lower portion of a side panel overlap one another such that an outer surface of each base rail is positioned against an inner surface of a side panel.

Indexing the cross-members to the base rails during manufacture to obtain proper spacing has high tooling costs and requires complicated moving of carriage fixtures. Accuracy of spacing and elimination of misalignment is also difficult and costly. Increased horizontal strength at the junction of the cross-members and the base rails is also desirable.

Additionally, the trailer needs to have drainage for moisture inside the cargo section. Cargo can be wet if, for example, it has been stored outside or is loaded into the trailer during rainy or snowy weather. Cargo stored at a lower temperature than ambient in the trailer may produce condensation that can drip onto the floor of the trailer, as will cargo during a time of temperature or humidity difference.

### BRIEF SUMMARY OF THE INVENTION

Briefly, and in accordance with the foregoing, a trailer having an interior section and an exterior has a base rail separating the interior section from the exterior. The base rail has a flange extending into the interior section. A cross-member is attached to the base rail, and a floor seal is attached to the cross-member and extends into the interior section. The floor seal is spaced from the flange to form a passageway from the interior section to the exterior.

### BRIEF DESCRIPTION OF THE SEVERAL VIEWS OF THE DRAWINGS

The organization and manner of the structure and operation of the invention, together with further objects and advantages thereof, may best be understood by reference to the following description, taken in connection with the accompanying drawings, wherein like reference numerals identify like elements in which:

FIG. 1 is perspective view of a combination of a floor seal, a base rail, and a cross-member;

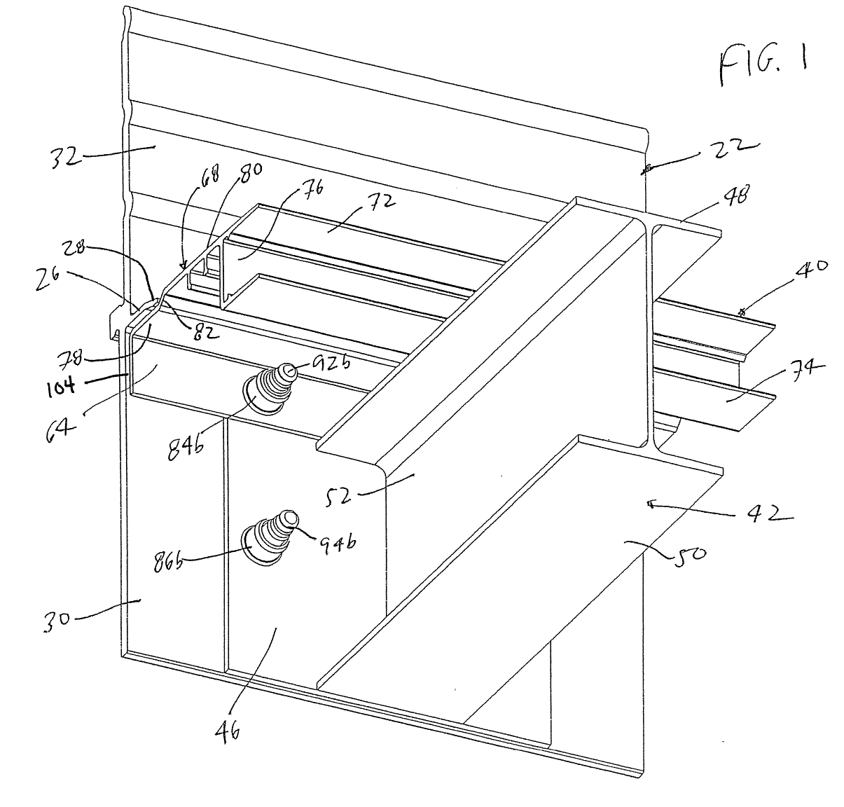

FIG. 2 is an elevational view of the combination of FIG. 1;

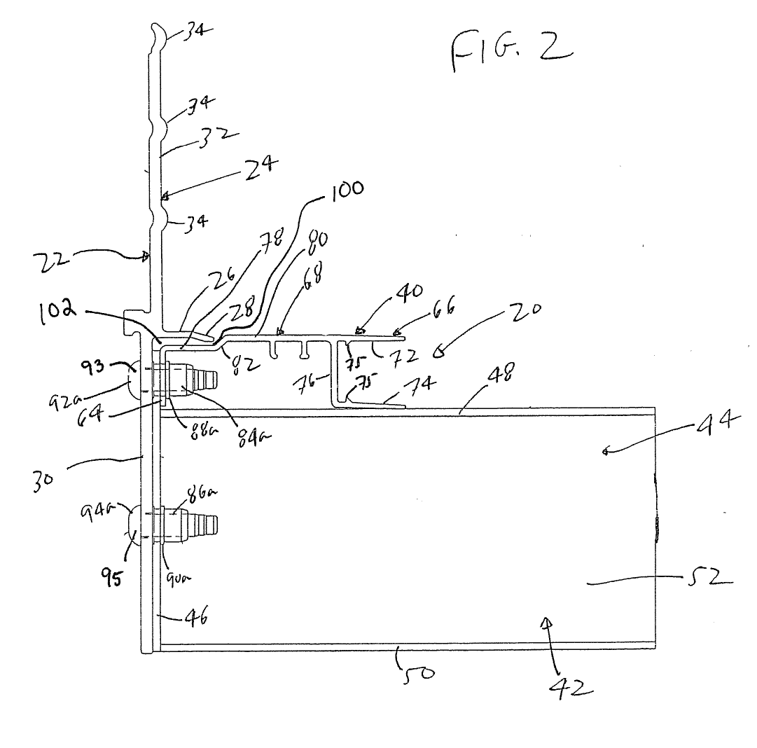

FIGS. 3 through 5 are perspective views showing the assembly of the combination of FIG. 1; and

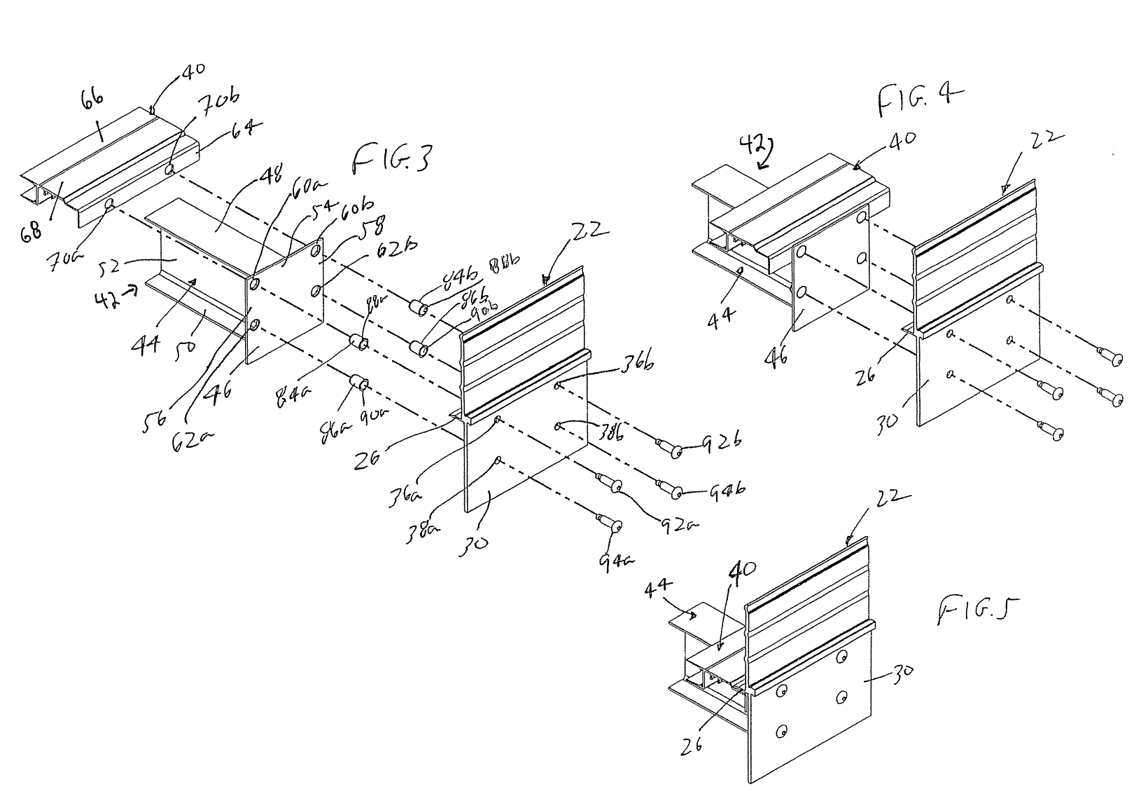

FIG. 6 is a perspective view of a prior art trailer using the combination of FIG. 1.

### DETAILED DESCRIPTION OF THE ILLUSTRATED EMBODIMENT OF THE INVENTION

While the invention may be susceptible to embodiment in different forms, there is shown in the drawings, and herein will be described in detail, a specific embodiment with the understanding that the present disclosure is to be considered an exemplification of the principles of the invention, and is not intended to limit the invention to that as illustrated and described herein.

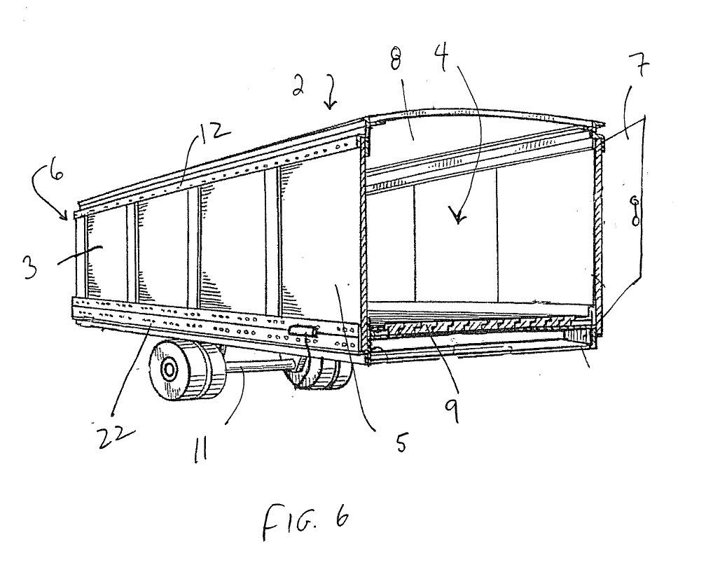

The present invention provides a floor seal connection 20 between a base rail 22 and a floor 9 of a trailer 2. As shown in FIG. 6, the trailer 2 generally includes a body 3 having an interior cargo section 4 enclosed by a pair of rectangular sidewalls 5, a front wall 6, at least one rear door 7 and the floor 9. A roof 8 may also form part of the cargo section 4. Conventionally, each sidewall 5 includes side panels 6, a base rail 22 and a top rail 12. The floor 9 is supported by cross-members 42 that extend between the base rails 22. An undercarriage assembly 11 is mounted underneath the floor 9. An upper portion of the side panels 6 is secured to the top rail 12. The top rail 12 supports the roof 8 of the trailer 2. The upper portion of the base rail 22 and the lower portion of a side panel 6 overlap one another such that an outer surface of each base rail 22 is positioned against an inner surface of a side panel 6.

The base rail 22 of the preferred embodiment of the present invention extends along the length of the trailer. The base rail 22 is formed of a vertical wall 24 having a generally horizontal flange 26 extending perpendicularly therefrom. As shown, the flange 26 has a downwardly extending tapered end 28 and is positioned at approximately the midpoint of the wall 24. The wall 24 is formed of a lower portion 30 that extends downwardly from the flange 26 and an upper portion 32 that extends upwardly from the flange 26. The upper portion 32 may have a series of indentations 34 at predetermined spaces along the upper portion 32. A sidewall of the trailer is attached to the upper portion 32 of the base rail 22 by suitable means, such as adhesive, bolts, screws, rivets, or welds.

An upper row of spaced apart apertures 36a, 36b are provided, such as by punching, in the lower portion 30 at a position proximate to, but spaced from, the flange 26. A lower row of spaced apart apertures 38a, 36b are provided, such as by punching, in the lower portion 30 at a position spaced downwardly from the upper row of apertures 36a, 36b. Pairs of apertures 36a, 38a and 36b, 38b in the upper and lower rows are aligned to form a series of columns.

The floor seal connection 20 includes a floor seal 40 and a plurality of spaced apart cross-members 42. The floor seal 40 extends along the length of the trailer. Only a single cross-member 42 is shown in the drawings, however, a plurality of cross-members 42 are provided at spaced apart locations along the base rail 22 and the floor seal 40. Each cross-member 42 is mounted on the lower portion 30 of the base rail 22 as described herein and the floor seal 40 is mounted on the cross-members 42. The floor seal 40 is positioned directly below the flange 26 of the base rail 22.

Each cross-member 42 is identical, and therefore only a single cross-member 42 is described. The cross-member 42 is integrally formed from an I-beam 44 that has end clips 46 at the opposite ends of the I-beam 44.

The I-beam 44 is conventionally formed and includes an upper horizontal wall 48, a lower horizontal wall 50 and a vertical bridge wall 52 extending between the upper and lower walls 48, 50. The vertical bridge wall 52 is at approximately the midpoint of the upper and lower horizontal walls 48, 50. The I-beam 44 extends across the width of the trailer and the floor sits on the upper surface of the I-beam 44.

Each end clip 46 is identical and therefore only one of the end clips is described. The end clip 46 is formed of a plate that has a top portion 54 which extends upwardly from the upper horizontal wall 48 of the I-beam 44, and opposite side portions 56, 58 which extend outwardly beyond the ends of the upper and lower horizontal walls 48, 50. As shown, the end clip 46 is square, but the end clip 46 may take other forms. An upper pair of spaced apart apertures 60a, 60b are provided, such as by punching, through the top portion 54, such that the apertures 60a, 60b are proximate to a top edge of the end clip 46 and proximate to the side edges of the end clip 46. A lower pair of spaced apart apertures 62a, 62b are provided through the side portions 56, 58, such as by punching, proximate the side edges of the end clip 46 and at approximately the midpoint of the end clip 46 along the height thereof.

The floor seal 40 is integrally formed from a vertical mounting section 64, a floor capturing section 66 and a generally horizontal bridge section 68 that extends therebetween. The vertical mounting section 64 has a row of spaced apart apertures 70a, 70b provided, such as by punching, therethrough. The floor capturing section 66 is used to capture an end of the floor so that the floor is secured to the floor seal 40. The floor capturing section 66 is generally U-shaped and has an upper horizontal wall 72 that is spaced apart from a lower horizontal wall 74 by a vertical base wall 76. The upper and lower walls 72, 74 have barbs 75 thereon for capturing an end of the floor when placed therebetween. The bridge section 68 is formed of an outer horizontal wall 78 which extends from an upper end of the mounting wall 64, an inner horizontal wall 80 which extends from an inner end of the upper horizontal wall 72 and an angled wall 82 which extends between the outer and inner horizontal walls 78, 80. The angled wall 82 angles upwardly from the outer horizontal wall 78, such that the inner horizontal wall 80 is positioned above the outer horizontal wall 78.

To assemble the floor seal connection 20 with the base rail 22, the floor seal 40 is seated on the cross-members 42. The outer surface of the vertical wall 64 of the floor seal 40 sits against the inner surface of the top portion 54 of the end clip 46, and the lower surface of the lower horizontal wall 74 sits against the upper surface of the upper horizontal wall 48 of the I-beam 44. The apertures 70a, 70b in the vertical wall 64 of the floor seal 40 align with the upper row of apertures 60a, 60b in the top portion 54 of the end clip 46. Next, the outer surface of the end clip 46 is abutted against the inner surface of the lower portion 30 of the base rail 22 such that the top portion 54 of the end clip 46 is proximate to the lower surface of the flange 26. The outer horizontal wall 78 of the bridge section 68 sits underneath the flange 26 of the base rail 22 and the angled wall 82 is proximate the tapered end 28. Accordingly, a passageway 100 is formed between the flange 28 and the floor seal 40.

The upper pair of apertures 36a, 36b through the lower portion 30 of the base rail 22 align with the aligned apertures 60a/70a, 60b/70b, and the lower pair of apertures 38a, 38b through the lower portion 30 of the base rail 22 align with the apertures 62a, 62b in the side portions 56, 58 of the end clip 46. Captive nuts 84a, 84b are seated against the inner surface of mounting section 64 of the floor seal 40 proximate to each of the apertures 70a, 70b, and captive nuts 86a, 86b are seated against the inner wall of the end clip 46 proximate to each of the apertures 62a, 62b. Each captive nut 84a, 84b has a shoulder 88a, 88b at the end that abuts the vertical wall 64 that is larger than the apertures 70a, 70b through the vertical wall 64, so that the captive nut 84a, 84b cannot pass through the vertical wall 64. Each captive nut 86a, 86b has a shoulder 90a, 90b at the end that abuts the end clip 46 that is larger than the apertures 62a, 62b through the end clip 46, so that the captive nut 86a, 86b cannot pass through the end clip 46. The captive nut 84a, 84b, 86a, 86b assembly to the floor seal 40 and the I-beam 44 permits the trailer to be fixtured and assembled in a more efficient manner. The captive nut 84a, 84b, 86a, 86b allows one-sided base rail bolt installation. The floor can be installed prior to the sidewall installation, so that there is more clearance and visibility for the installation of the floor. Alternatively, a washer could be used but the captive nut/shoulder arrangement allows for more efficient manufacture and is therefore preferable.

Internal threads are provided in a passageway through each captive nut 84a, 84b, 86a, 86b. Upper bolts 92a, 92b having threaded shanks are then placed through the respective aligned apertures 36a/60a/70a; 36b/60b/70b and are engaged with the associated captive nut 84a; 84b by passing the shank of the bolt 92a, 92b through the lower portion 30 of the base rail 22, then through the end clip 46 and the vertical wall 64 of the floor seal 40, and then threaded into engagement with the captive nut 84a, 84b to secure the cross-member 42 to the base rail 22. This arrangement also secures the floor seal 40 to the cross-member 42 and to the base rail 22. An enlarged head 93 on the end of each shank abuts against the outer surface of the lower portion 30 of the base rail 22. Lower bolts 94a, 94b having threaded shanks are then placed through the respective aligned apertures 38a/62a; 38b/62b and are engaged with the associated captive nut 86a, 86b by passing a shank of the bolt 94a, 94b through the base rail 22, then through the end clip 46, and then threaded into engagement with the captive nut 86a, 86b to secure the further cross-member 42 to the base rail 22. An enlarged head 95 on the end of each shank abuts against the outer surface of the lower portion 30 of the base rail 22. As a result, the floor seal 40 is bolted to the base rail 22 and is bolted directly to the cross-members 42. This arrangement provides an increase in horizontal strength at the base rail 22 because of the bolted floor seal 40.

A pre-punched floor seal 40 can be used to index the spacings of the cross-members 42 to match-up with a pre-punched base rail 22. This method results in a lower tooling cost and simplifies moving carriage fixtures during manufacture. In addition, improved accuracy of the locations of the cross-members 42 is provided because aperture alignment issues are eliminated. All alignment is determined by the pre-punched floor seal 40, not by layout and alignment of the cross-members 42.

The passageway 100 formed between tapered end 28 and angled wall 82 leads to a cavity 102 formed by spacing the horizontal flange 26 away from outer wall 78. The floor seal horizontal wall 80 is preferably at the same level or below the level of the floor, so that cavity 102 is a low point for collection of moisture. The cavity 102 opens to air at the front end and rear end of trailer, and to a cavity 104 formed between the mounting section 64 of the floor seal 40 and the lower portion 30 of the base rail 22, between each crossmember 42. Liquid within the interior (or cargo) section of the trailer will drain through passageway 100 and into cavity 102. The liquid will then drain out either end of the trailer or out through the cavity 104 to the exterior of trailer.

While a preferred embodiment of the present invention is shown and described, it is envisioned that those skilled in the art may devise various modifications of the present invention without departing from the spirit and scope of the appended claims.

The invention is claimed as follows:

1. A trailer having an interior section comprising:
a base rail having a flange extending into the interior section;
a cross-member attached to said base rail; and
a floor seal attached to said cross-member and extending into the interior section, said floor seal spaced from said flange to form a passageway from the interior section to the exterior of the trailer.

2. The trailer system of claim 1, wherein said cross-member comprises an end clip plate attached to said base rail, and said floor seal comprises a vertical wall mounted to said end clip plate and a bridge section extending from said vertical wall into said interior section.

3. The trailer system of claim 2, wherein said bridge section comprises an outer wall extending from said vertical wall, an angled wall extending upwardly from said outer wall, and an inner wall extending from said angled wall.

4. The trailer system of claim 1, wherein said floor seal further comprises means for capturing a floor mounted on said cross-member.

5. The trailer system of claim 1, further comprising a first aperture through said base rail, said cross-member, and said floor seal, a bolt placed through said first aperture, and a nut engaging said bolt.

6. The trailer system of claim 5, wherein said nut is a captive nut.

7. The trailer system of claim 5, wherein said nut has a shoulder larger than said aperture.

8. The trailer system of claim 7, wherein said nut is a captive nut.

9. The trailer system of claim 1, further comprising a second aperture through said base rail and said cross-member, a bolt placed through said aperture, and a nut engaging said bolt.

10. The trailer system of claim 9, wherein said nut is a captive nut.

11. The trailer system of claim 9, wherein said nut has a shoulder larger than said aperture.

12. The trailer system of claim 11, wherein said nut is a captive nut.

13. The trailer system of claim 1, wherein said cross-member comprises an I-beam.

14. A trailer comprising:
a cargo section defined by a front wall, at least one rear door, a floor, and a pair of sidewalls, each of said sidewalls comprising a side panel and a base rail, each said base rail comprising a vertical wall having a flange extending into said cargo section;
a plurality of cross-members each comprising a bridge section, a first end clip, and a second end clip, each of said plurality of cross-members spanning from a first base rail of said pair of sidewalls to a second base rail of said pair of sidewalls, said plurality of cross-members supporting said floor;
a floor seal comprising a vertical wall, an outer wall extending from said vertical wall, an angled wall extending upwardly from said outer wall, and an inner wall extending from said angled wall, said inner wall further comprising means to capture said floor, said vertical wall mounted to a one of said first end clip and said second end clip and oriented so that said outer wall, said angled wall, and said inner wall extend into said cargo section, said floor seal spaced from said flange to form a passageway between said flange and said floor seal;
an upper row of apertures formed in each said base rail below said flange, each said upper base rail aperture being located along a length of said base rail to correspond in space to a predetermined location of a one of said plurality of cross-members;
a lower row of apertures formed in each said base rail below said upper row, each said lower base rail aperture being located along a length of said base rail to correspond in space to a predetermined location of a one of said plurality of cross-members;
a row of apertures formed in said vertical wall of said floor seal, said floor seal apertures being located along a length of said floor seal to correspond in space to a predetermined location of a one of said plurality of cross-members;
a pair of apertures formed in an upper portion of each said end clip;
a pair of apertures formed in a lower portion of each said end clip;
a plurality of upper bolts, each said upper bolt extending through a one of said apertures in said upper row of apertures, a one of said pair of upper portion apertures in a one of said end clips, and a one of said apertures in said row of floor seal apertures, each said upper bolt of said plurality of upper bolts having an enlarged head;
a plurality of lower bolts, each said lower bolt extending through a one of said apertures in said lower row of apertures and a one of said pair of lower portion apertures in a one of said end clips, each said lower bolt of said plurality of lower bolts having an enlarged head and a threaded shank;
a plurality of captive nuts, each said captive nut fastened to a threaded shank of a one of said plurality of upper bolts and said plurality of lower bolts.

15. A method of manufacturing a trailer having an interior, a base rail having a flange extending into said interior, a plurality of cross-members attached to said base rail and supporting a floor, said plurality of cross-members being spaced apart, and a floor seal attached to said cross-members and extending into said interior, said floor seal spaced from said flange to form a passageway from said interior section to said exterior, the method comprising:
providing apertures in said floor seal;
providing apertures in said base rail;
using said floor seal to index a spacing of a one of said plurality of cross-members from a second one of said plurality of cross-members by matching said apertures in said floor seal to said apertures in said base rail.
